(19) United States
(12) Patent Application Publication
(10) Pub. No.: US 2023/0259892 A1
(43) Pub. Date: Aug. 17, 2023

(54) DIGITAL PLATFORM BASED MULTIFACETED RISK ASSESSMENT FOR EXTENSION OF TURBOMACHINERY SERVICE INTERVALS

(71) Applicant: Solar Turbines Incorporated, San Diego, CA (US)

(72) Inventors: Scott M. LINDNER, San Diego, CA (US); Lindsay JONES TSUJI, La Mesa, CA (US); Matthew P. HARVEY, San Diego, CA (US); Brandon W. STEIN, El Cajon, CA (US); Fabrice M. MURGIA, Spring, TX (US); Chad Vincent PALMER, San Diego, CA (US)

(73) Assignee: Solar Turbines Incorporated, San Diego, CA (US)

(21) Appl. No.: 17/674,771

(22) Filed: Feb. 17, 2022

(51) Int. Cl. G06Q 10/00

(52) U.S. Cl. CPC G06Q 10/20

(57) ABSTRACT

An owner or operator of a turbomachine, such as a gas turbine engine, may wish to extend a service interval for the turbomachine. A framework is disclosed that enables automation of various aspects of the review process, including the generation of a risk assessment for the service interval extension. Data, including equipment data, may be aggregated from a plurality of different data silos. A physics-based model may be applied to the equipment data to calculate a remaining useful life of the equipment, which may then be used to generate the risk assessment. In addition, the framework may facilitate multiple levels of evaluation of the risk assessment to increase confidence in a final approval or denial of the service interval extension.

### BACKGROUND

### Field of the Invention

The embodiments described herein are generally directed to turbomachinery, and, more particularly, to a digital platform for assessing the risks of extending the service interval of turbomachinery.

### Description of the Related Art

The owner and/or operator of a turbomachine, such as a gas turbine engine, may wish to extend its service interval. The service interval, which may also be referred to as the time between overhaul (TBO), refers to the duration of time until the turbomachine is next serviced (e.g., overhauled). There may be a number of reasons to extend the service interval, including the deferment of overhaul expenses (e.g., by utilizing the turbomachine to the maximum extent of its useful life), the prevention or deferment of disruptions to operations and risks to the operator’s facilities or production, and/or the like. In practice, the owner/operator of a turbomachine may request an extension to a service interval from the seller of the turbomachine, which may be the original equipment manufacturer (OEM) of the turbomachine.

Currently, the assessment of risk for extending a service interval is done manually. Despite the proliferation of computing-based assessments, it has not been possible to automate the risk assessment for extending a service interval. For example, International Patent Pub. No. WO/2021/175493 describes a method for optimizing maintenance of turbomachinery that comprises the calculation of a risk assessment, and U.S. Pat. No. 10,823,016 describes a method for calculating the risk of failure for a turbomachine. However, neither of these references address a risk assessment for extending a service interval of a turbomachine.

The present disclosure is directed toward overcoming one or more of the obstacles to facilitating and automating risk assessment for extending a service interval, as well as other problems discovered by the inventors.

### SUMMARY

Accordingly, a digital platform is disclosed for assessing the risk of extending the service interval of turbomachinery.

In an embodiment, a method comprises using at least one hardware processor to: receive request information, representing a request for a service interval extension for an equipment, the request information including a requested amount of the service interval extension; collect equipment data, including actual operating parameters of the equipment; apply a physics-based model, associated with the equipment, to the equipment data to calculate a remaining useful life of the equipment; generate a risk assessment based on the equipment data and the remaining useful life of the equipment, the risk assessment including a recommended amount of the service interval extension; and either approve or deny the service interval extension for the recommended amount based on the risk assessment.

In an embodiment, a system comprises: at least one hardware processor; and one or more software modules that are configured to, when executed by the at least one hardware processor, receive request information, representing a request for a service interval extension for an equipment, the request information including a requested amount of the service interval extension, collect equipment data, including actual operating parameters of the equipment, apply a physics-based model, associated with the equipment, to the equipment data to calculate a remaining useful life of the equipment, generate a risk assessment based on the equipment data and the remaining useful life of the equipment, the risk assessment including a recommended amount of the service interval extension, and either approve or deny the service interval extension for the recommended amount based on the risk assessment.

In an embodiment, a non-transitory computer-readable medium having instructions stored therein, wherein the instructions, when executed by a processor, cause the processor to: receive request information, representing a request for a service interval extension for an equipment, the request information including a requested amount of the service interval extension; collect equipment data, including actual operating parameters of the equipment; apply a physics-based model, associated with the equipment, to the equipment data to calculate a remaining useful life of the equipment; generate a risk assessment based on the equipment data and the remaining useful life of the equipment, the risk assessment including a recommended amount of the service interval extension; and either approve or deny the service interval extension for the recommended amount based on the risk assessment.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates a schematic diagram of a gas turbine engine, according to an embodiment;

FIG. 2 illustrates an example infrastructure, in which one or more of the processes described herein, may be implemented, according to an embodiment,

FIG. 3 illustrates an example processing system, by which one or more of the processes described herein, may be executed, according to an embodiment; and

FIG. 4 illustrates a process for assessing the risk of extending the service interval of turbomachinery, according to an embodiment.

### DETAILED DESCRIPTION

The detailed description set forth below, in connection with the accompanying drawings, is intended as a description of various embodiments, and is not intended to represent the only embodiments in which the disclosure may be practiced. The detailed description includes specific details for the purpose of providing a thorough understanding of the embodiments. However, it will be apparent to those skilled in the art that embodiments of the invention can be practiced without these specific details. In some instances, well-known structures and components are shown in simplified form for brevity of description.

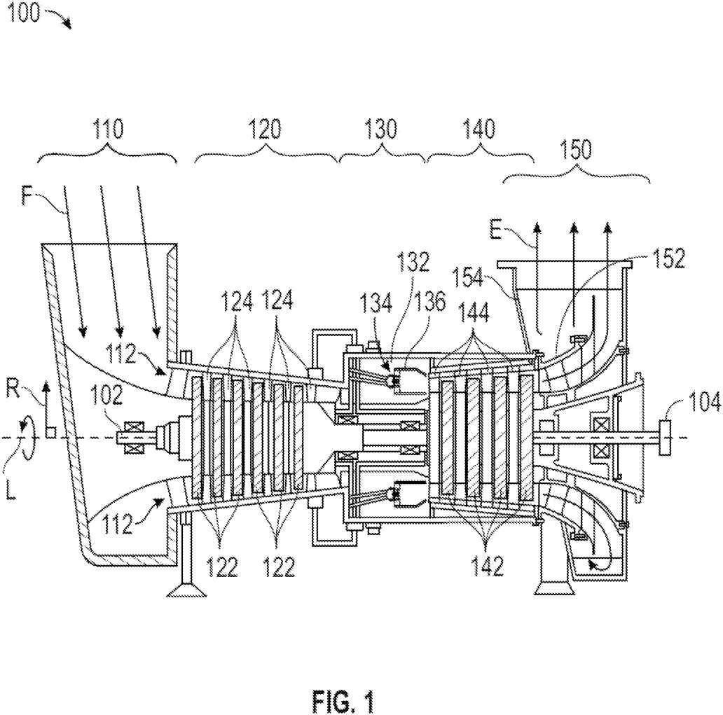

FIG. 1 illustrates a schematic diagram of a gas turbine engine 100, according to an embodiment. Gas turbine engine 100 comprises a shaft 102 with a central longitudinal axis L. A number of other components of gas turbine engine 100 are concentric with longitudinal axis L and may be annular to longitudinal axis L. A radial axis may refer to any axis or direction that radiates outward from longitudinal axis L at a substantially orthogonal angle to longitudinal axis L, such as radial axis R in FIG. 1.

In an embodiment, gas turbine engine 100 comprises, from an upstream end to a downstream end, an inlet 110, a compressor 120, a combustor 130, a turbine 140, and an exhaust outlet 150. In addition, the downstream end of gas turbine engine 100 may comprise a power output coupling 104. One or more, including potentially all, of these components of gas turbine engine 100 may be made from stainless steel and/or durable, high-temperature materials known as “superalloys.” A superalloy is an alloy that exhibits excellent mechanical strength and creep resistance at high temperatures, good surface stability, and corrosion and oxidation resistance. Examples of superalloys include, without limitation, Hastelloy, Inconel, Waspaloy, Rene alloys, Haynes alloys, Incoloy, MP98T, TMS alloys, and CMSX single crystal alloys.

Inlet 110 may funnel a working fluid F (e.g., the primary gas, such as air) into an annular flow path 112 around longitudinal axis L. Working fluid F flows through inlet 110 into compressor 120. While working fluid F is illustrated as flowing into inlet 110 from a particular direction and at an angle that is substantially orthogonal to longitudinal axis L, it should be understood that inlet 110 may be configured to receive working fluid F from any direction and at any angle that is appropriate for the particular application of gas turbine engine 100.

Compressor 120 may comprise a series of compressor rotor assemblies 122 and stator assemblies 124. Each compressor rotor assembly 122 may comprise a rotor disk that is circumferentially populated with a plurality of rotor blades. The rotor blades in a rotor disk are separated, along the axial axis, from the rotor blades in an adjacent disk by a stator assembly 124. Compressor 120 compresses working fluid F through a series of stages corresponding to each compressor rotor assembly 122. The compressed working fluid F then flows from compressor 120 into combustor 130.

Combustor 130 may comprise a combustor case 132 that houses one or more, and generally a plurality of, fuel injectors 134. In an embodiment with a plurality of fuel injectors 134, fuel injectors 134 may be arranged circumferentially around longitudinal axis L within combustor case 132 at equidistant intervals. Combustor case 132 diffuses working fluid F, and fuel injector(s) 134 inject fuel into working fluid F. This injected fuel is ignited to produce a combustion reaction in one or more combustion chambers 136. The combusting fuel-gas mixture drives turbine 140.

Turbine 140 may comprise one or more turbine rotor assemblies 142 and stator assemblies 144 (e.g., nozzles). Each turbine rotor assembly 142 may correspond to one of a plurality or series of stages. Turbine 140 extracts energy from the combusting fuel-gas mixture as it passes through each stage. The energy extracted by turbine 140 may be transferred (e.g., to an external system) via power output coupling 104.

The exhaust E from turbine 140 may flow into exhaust outlet 150. Exhaust outlet 150 may comprise an exhaust diffuser 152, which diffuses exhaust E, and an exhaust collector 154 which collects, redirects, and outputs exhaust E. It should be understood that exhaust E, output by exhaust collector 154, may be further processed, for example, to reduce harmful emissions, recover heat, and/or the like. In addition, while exhaust E is illustrated as flowing out of exhaust outlet 150 in a specific direction and at an angle that is substantially orthogonal to longitudinal axis L, it should be understood that exhaust outlet 150 may be configured to output exhaust E towards any direction and at any angle that is appropriate for the particular application of gas turbine engine 100.

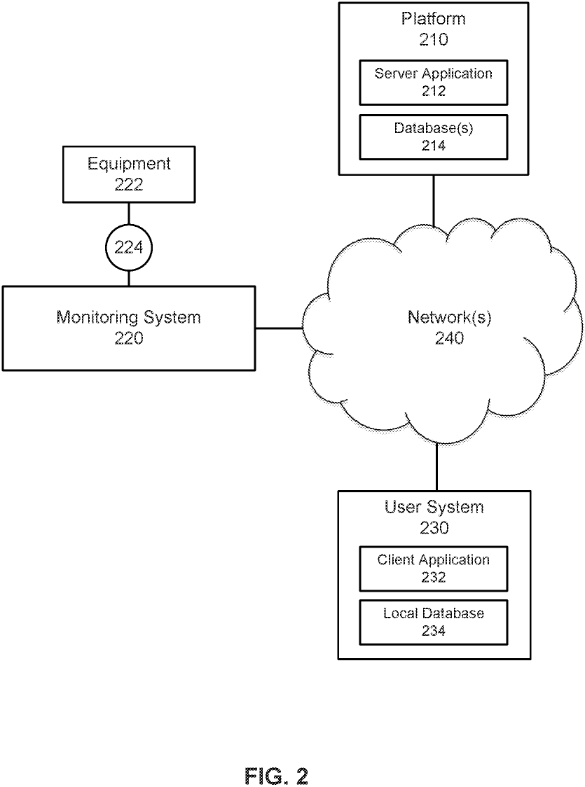

FIG. 2 illustrates an example infrastructure in which one or more of the disclosed processes may be implemented, according to an embodiment. The infrastructure may comprise a platform 210 (e.g, one or more servers) which hosts and/or executes one or more of the various functions, processes, methods, and/or software modules described herein. Platform 210 may comprise dedicated servers, or may instead comprise cloud instances, which utilize shared resources of one or more servers. These servers or cloud instances may be collocated and/or geographically distributed. Platform 210 may also comprise or be communicatively connected to a server application 212 and/or one or more databases 214. In addition, platform 210 may be communicatively connected to one or more monitoring systems 220 and/or one or more user systems 230 via one or more networks 240. While only a single instance of monitoring system 220 and a single instance of user system 230 are illustrated, it should be understood that the infrastructure may comprise any number of monitoring systems 220 and any number of user systems 230, communicatively coupled to platform 210 via network(s) 240.

Network(s) 240 may comprise the Internet, and platform 210 may communicate with monitoring system(s) 220 and/or user system(s) 230 through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 210 is illustrated as being connected to various systems through a single set of network(s) 240, it should be understood that platform 210 may be connected to the various systems via different sets of one or more networks. For example, platform 210 may be connected to a subset of monitoring systems 220 and/or user systems 230 via the Internet, but may be connected to one or more other monitoring systems 220 and/or user systems 230 via an intranet.

Each monitoring system 220 may monitor one or a plurality of equipment 222. It is generally contemplated that equipment 222 comprises a gas turbine engine 100. However, disclosed embodiments may be adapted for any type of equipment 222 that is maintained according to service intervals and/or overhauled at the end of a useful life. Regardless of the type of equipment 222, values of various parameters of equipment 222 may be sensed by one or more sensors 224 and provided as output to monitoring system 220. Monitoring system 220 may then provide the raw and/or processed output of sensors 224, and/or data derived from the output of sensors 224, to server application 212 on platform 210 for analysis and/or storage in database(s) 214. Monitoring system 220 may process the output of sensors 224 in some manner, or may simply act as a gateway or router that relays the output of sensors 224 to platform 210. While only a single instance of equipment 222 and a single instance of sensor 224 are illustrated, it should be understood that any number of equipment 222 and sensors 224 may be monitored by each individual monitoring system 220.

Each user system 230 may comprise any type of computing device capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. However, it is generally contemplated that each user system 230 is the personal or work device of a user that operates, manages, assesses, and/or approves an extension of a service interval for equipment 222. Different users with different roles will utilize their particular user systems 230 to interact with server application 212 on platform 210 in accordance with their individual roles. Each user system 230 may comprise or be communicatively connected to a client application 232 and/or one or more local databases 234.

Platform 210 may comprise web servers which host one or more websites and/or web services. In embodiments in which a website is provided, the website may comprise a graphical user interface, including, for example, one or more screens (e.g., webpages) generated in HyperText Markup Language (HTML) or other language. Platform 210 transmits or serves one or more screens of the graphical user interface, which may be generated by server application 212, in response to requests from user system(s) 230. In some embodiments, these screens may be served in the form of a wizard, in which case two or more screens may be served in a sequential manner, and one or more of the sequential screens may depend on an interaction of the user or user system 230 with one or more preceding screens. The requests to platform 210 and the responses from platform 210, including the screens of the graphical user interface, may both be communicated through network(s) 240, which may include the Internet, using standard communication protocols (e.g., HTTP, HTTPS, etc.) These screens (e.g., webpages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (e.g., database(s) 214) that are locally and/or remotely accessible to platform 210

As mentioned above, platform 210 may comprise, be communicatively coupled with, or otherwise have access to one or more database(s) 214. For example, platform 210 may comprise one or more database servers which manage one or more databases 214. Server application 212 executing on platform 210, and/or client application 232 executing on user system 230, may submit data (e.g., user data, form data, any of the user input or other data described herein, etc.) to be stored in database(s) 214, and/or request access to data stored in database(s) 214. Any suitable database may be utilized, including without limitation MySQL®, Oracle®, IBM®, Microsoft SQL®, Access®, PostgreSQL®, and the like, including cloud-based databases and proprietary databases. Data may be sent to platform 210, for instance, using the well-known POST request supported by HTTP, via FTP, and/or the like. This data, as well as other requests, may be handled, for example, by server-side web technology, such as a servlet or other software module (e.g., comprised in server application 212), executed by platform 210.

In embodiments in which a web service is provided, platform 210 may receive requests from external systems, and provide responses in eXtensible Markup Language (XML), JavaScript Object Notation (JSON), and/or any other suitable or desired format. In such embodiments, platform 210 may provide an application programming interface (API) which defines the manner in which monitoring system(s) 220, user system(s) 230, and/or other external system(s) may interact with the web service. Thus, monitoring system(s) 220, user system(s) 230, and/or other external systems (which may themselves be servers), can define their own user interfaces, and rely on the web service to implement or otherwise provide the backend processes, methods, functionality, storage, and/or the like, described herein. For example, in such an embodiment, a client application 232, executing on one or more user system(s) 230, may interact with a server application 212 executing on platform 210 to execute one or more or a portion of one or more of the various functions, processes, methods, and/or software modules described herein. In this case, client application 232 may generate the graphical user interface. In an embodiment, client application 232 may utilize a local database 234 for storing data locally on user system 230.

Client application 232 may be “thin,” in which case processing is primarily carried out server-side by server application 212 on platform 210. A basic example of a thin client application 232 is a browser application, which simply requests, receives, and renders webpages at user system(s) 230, while server application 212 on platform 210 is responsible for generating the webpages and managing database functions. Alternatively, the client application may be “thick,” in which case processing is primarily carried out client-side by user system(s) 230. It should be understood that client application 232 may perform an amount of processing, relative to server application 212 on platform 210, at any point along this spectrum between “thin” and “thick,” depending on the design goals of the particular implementation. In any case, the software described herein, which may wholly reside on either platform 210 (e.g., in which case server application 212 performs all processing) or user system(s) 230 (e.g., in which case client application 232 performs all processing) or be distributed between platform 210 and user system(s) 230 (e.g., in which case server application 212 and client application 232 both perform processing), can comprise one or more executable software modules comprising instructions that implement one or more of the processes, methods, or functions described herein.

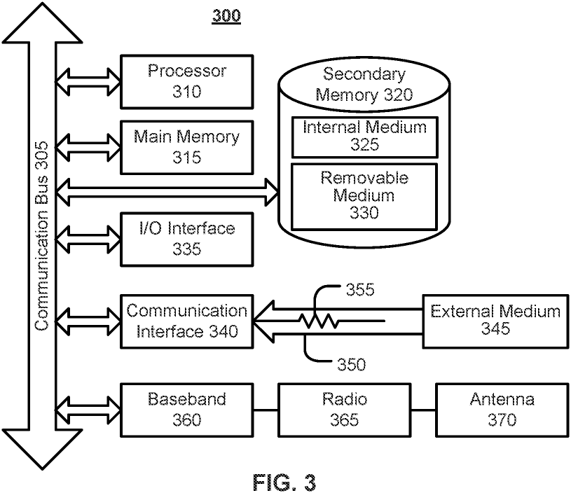

FIG. 3 is a block diagram illustrating an example wired or wireless system 300 that may be used in connection with various embodiments described herein. For example, system 300 may be used as or in conjunction with one or more of the functions, processes, or methods (e.g., to store and/or execute the software) described herein, and may represent components of platform 210, monitoring system(s) 220, equipment 222, sensor(s) 224, user system(s) 230, and/or other processing devices described herein. System 300 can be a server or any conventional personal computer, or any other processor-enabled device that is capable of wired or wireless data communication. Other computer systems and/or architectures may be also used, as will be clear to those skilled in the art.

System 300 preferably includes one or more processors 310. Processor(s) 310 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a slave processor subordinate to the main processing system (e.g., back-end processor), an additional microprocessor or controller for dual or multiple processor systems, and/or a coprocessor. Such auxiliary processors may be discrete processors or may be integrated with processor 310. Examples of processors which may be used with system 300 include, without limitation, any of the processors (e.g., Pentium™, Core i7®, Xeon®, etc.) available from Intel Corporation of Santa Clara, California, any of the processors available from Advanced Micro Devices, Incorporated (AMD) of Santa Clara, California, any of the processors (e.g, A series, M series, etc.) available from Apple Inc. of Cupertino, any of the processors (e.g., Exynos®) available from Samsung Electronics Co., Ltd., of Seoul, South Korea, any of the processors available from NXP Semiconductors N.V. of Eindhoven, Netherlands, and/or the like.

Processor 310 is preferably connected to a communication bus 305. Communication bus 305 may include a data channel for facilitating information transfer between storage and other peripheral components of system 300. Furthermore, communication bus 305 may provide a set of signals used for communication with processor 310, including a data bus, address bus, and/or control bus (not shown). Communication bus 305 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 300 preferably includes a main memory 315 and may also include a secondary memory 320. Main memory 315 provides storage of instructions and data for programs executing on processor 310, such as any of the software discussed herein. It should be understood that programs stored in the memory and executed by processor 310 may be written and/or compiled according to any suitable language, including without limitation C/C++, Java, JavaScript, Perl, Visual Basic, .NET, and the like. Main memory 315 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Secondary memory 320 is a non-transitory computer-readable medium having computer-executable code (e.g., any of the software disclosed herein) and/or other data stored thereon. The computer software or data stored on secondary memory 320 is read into main memory 315 for execution by processor 310. Secondary memory 320 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 320 may optionally include an internal medium 325 and/or a removable medium 330. Removable medium 330 is read from and/or written to in any well-known manner. Removable storage medium 330 may be, for example, a magnetic tape drive, a compact disc (CD) drive, a digital versatile disc (DVD) drive, other optical drive, a flash memory drive, and/or the like.

In an embodiment, I/O interface 335 provides an interface between one or more components of system 300 and one or more input and/or output devices. Example input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing devices, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display (e.g., in a smartphone, tablet computer, or other mobile device).

System 300 may include a communication interface 340. Communication interface 340 allows software and data to be transferred between system 300 and external devices (e.g. printers), networks, or other information sources. For example, computer software or executable code may be transferred to system 300 from a network server (e.g., platform 210) via communication interface 340. Examples of communication interface 340 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 300 with a network (e.g., network(s) 240) or another computing device. Communication interface 340 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 340 are generally in the form of electrical communication signals 355. These signals 355 may be provided to communication interface 340 via a communication channel 350 In an embodiment, communication channel 350 may be a wired or wireless network (e.g., network(s) 240), or any variety of other communication links. Communication channel 350 carries signals 355 and can be implemented using a variety of wired or wireless communication means including wire or cable, fiber optics, conventional phone line, cellular phone link, wireless data communication link, radio frequency (“RF”) link, or infrared link, just to name a few.

Computer-executable code (e.g., computer programs, such as the disclosed software) is stored in main memory 315 and/or secondary memory 320. Computer-executable code can also be received via communication interface 340 and stored in main memory 315 and/or secondary memory 320. Such computer programs, when executed, enable system 300 to perform various functions of the disclosed embodiments as described elsewhere herein.

In this description, the term “computer-readable medium” is used to refer to any non-transitory computer-readable storage media used to provide computer-executable code and/or other data to or within system 300. Examples of such media include main memory 315, secondary memory 320 (including internal memory 325 and/or removable medium 330), external storage medium 345, and any peripheral device communicatively coupled with communication interface 340 (including a network information server or other network device). These non-transitory computer-readable media are means for providing software and/or other data to system 300.

System 300 may also include optional wireless communication components that facilitate wireless communication over a voice network and/or a data network (e.g., in the case of user system 330). The wireless communication components comprise an antenna system 370, a radio system 365, and a baseband system 360. Baseband system 360 is communicatively coupled with processor(s) 310. In system 300, radio frequency (RF) signals are transmitted and received over the air by antenna system 370 under the management of radio system 365.

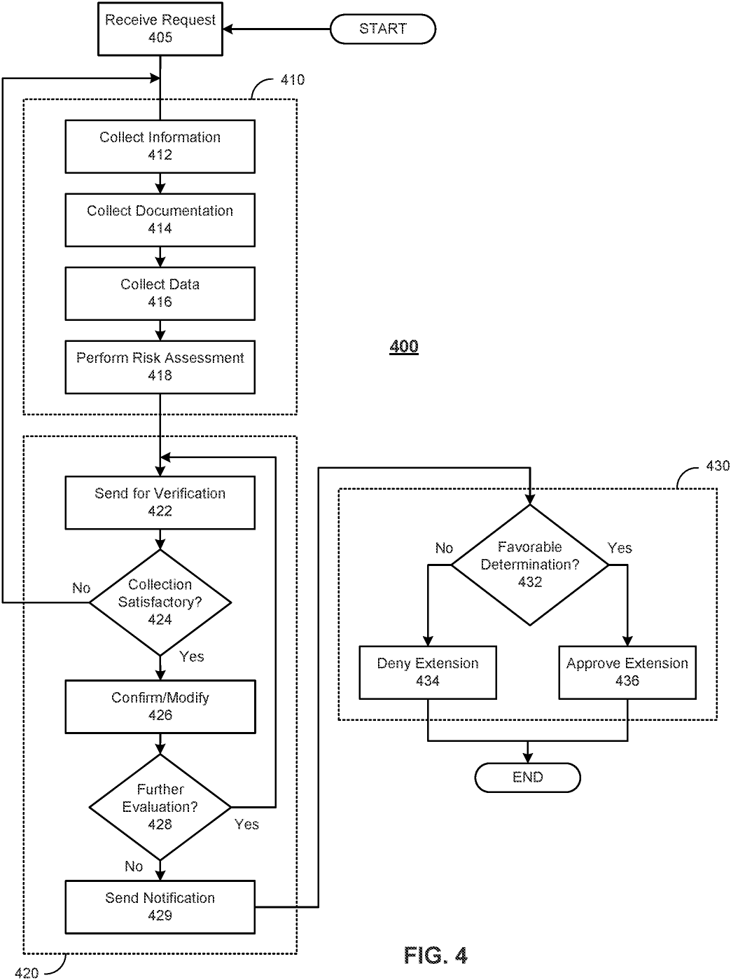

FIG. 4 illustrates a process 400 for assessing the risk of extending the service interval of turbomachinery, according to an embodiment. Process 400 may be implemented by server application 212 on platform 210 (e.g., comprising system 300). Any of the user operations and interactions described herein, such as the input of data by a user during any portion of process 400, may be performed via a graphical user interface that is generated by server application 212, client application 232, and/or a combination of server application 212 and client application 232.

In an embodiment, process 400 may comprise a collection stage 410, an evaluation stage 420, and an outcome stage 430. While process 400 is illustrated with a certain arrangement and ordering of subprocesses, process 400 may be implemented with fewer, more, or different subprocesses and a different arrangement and/or ordering of subprocesses. In addition, any subprocess, which does not depend on the completion of another subprocess, may be executed before, after, or in parallel with that other independent subprocess, even if the subprocesses are described or illustrated in a particular order.

Initially, in subprocess 405, a request for a service interval extension for an equipment 222 may be received from a customer. The customer may submit the request to platform 210 via a user system 230 of the customer. For example, the customer may log in to a user account, associated with the customer, on platform 210, and submit the request via one or more inputs of a screen of the graphical user interface. Alternatively, the customer may submit the request via email message, telephone communications, mail, fax, and/or the like. In this case, a user of platform 210 may receive the request and submit the request to server application 212 via one or more inputs of a screen of the graphical user interface. The customer may be the owner and/or operator of equipment 222. Equipment 222 may be gas turbine engine 100, another type of turbomachine, or any machine that is serviced according to a service interval. The request may comprise an identifier of the customer, an identifier of the equipment 222, an amount of the service interval extension that is being requested, and/or the like. The amount of service interval extension may be expressed in terms of operating hours or any other unit by which the life of equipment 222 may be measured. As an example, a customer operating a gas turbine engine 100, with current operating hours of 26,000 hours, may request an extension of the time before overhaul from 30,000 hours to 40,000 hours.

As illustrated, collection stage 410 may comprise subprocesses 412, 414, 416, and 418. Subprocesses 412, 414, and 416 collect various types of data, and subprocess 418 analyzes the collected data. In other words, subprocesses 412, 414, and 416 represent a data pipeline that drives or otherwise informs a risk assessment in subprocess 418. In an embodiment, subprocesses 412, 414, and 416 are independent subprocesses that may be performed in any order or in parallel with each other. In an alternative embodiment, one or more of subprocesses 412, 414, and 416 may be omitted. Each of subprocesses 412, 414, and 416 may be a continuous process that extends over a single continuous time period or may be a discontinuous process that occurs periodically or arbitrarily over multiple discontinuous time periods. Subprocess 418 may be performed after all of the various types of data have been collected by subprocesses 412, 414, and 416, or may be performed as data are collected by subprocesses 412, 414, and/or 416. Any manual portions of the various subprocesses in collection stage 410 may be performed by a single user, such as an initial assessor (e.g., a fleet manager), or may be performed by multiple, different users.

In subprocess 412, request information is collected. This request information may comprise the information in the request, received in subprocess 405, including the identifier of the customer that is requesting a service interval extension, the identifier of the equipment 222 (e.g., serial number) for which a service interval extension is being requested, and the amount of the service interval extension (e.g., in terms of operating hours) that is being requested for equipment 222. The request information may also identify the individuals and/or roles required to perform the subsequent risk assessment (e.g., according to one or more tiers of approval), and the individuals to be notified of the assessment process, changes during the assessment process, and/or the outcome of the assessment process. Some of the request information may be collected automatically, while other request information may be collected manually via the graphical user interface. Alternatively, all of the request information may be collected automatically, or all of the request information may be collected manually.

In subprocess 414, documentation is collected. This documentation may comprise technical reports resulting from physical inspections of the equipment 222 that was identified in the request information collected in subprocess 412. For example, if equipment 222 comprises a gas turbine engine 100, these technical reports may include, without limitation, borescope reports, condition assessment reports, analytics reports, lube oil laboratory analyses, and/or the like. Alternatively or additionally, the documentation may comprise technical manuals, equipment diagrams, diagnostic charts, and/or any other machine-readable, textual, and/or graphical information relevant to assessing the risk of extending a service interval for equipment 222. The documentation may be collected manually via the graphical user interface and/or retrieved automatically from a data store (e.g., in database 114) that is associated with equipment 222.

In subprocess 416, equipment data are collected. The equipment data may comprise machine data collected from the equipment 222 that was identified in the request information collected in subprocess 412. This machine data may be received and/or derived from sensors 224 that are integrated into or attached to components of equipment 222 and configured to output the values of various operating parameters of equipment 222. For example, if equipment 222 comprises a gas turbine engine 100, the machine data may comprise values representing or related to levels of vibration, lube oil, combustion, temperature, compression, fuel, and/or the like, in gas turbine engine 100. The machine data may be collected in real time and/or may comprise historical data that are periodically collected (e.g., every two weeks) for specific time ranges (e.g., most recent 6 months). Example implementations of a monitoring system 220 that may be used to collect the machine data from equipment 222 and provide the data to platform 210 in subprocess 416 are described in U.S. Pat. No. 9,625,901, issued on Apr. 18, 2017, which is hereby incorporated herein by reference as if set forth in full.

The machine data may be collected manually via the graphical user interface and/or collected automatically (e.g., via communications between monitoring system 220 and platform 210). In an implementation in which the machine data are collected automatically, the machine data may be “pushed” by monitoring system 220 to platform 210 over network(s) 240 via an API provided by platform 210. Alternatively, the machine data may be “pulled” by platform 210 from monitoring system 220 over network(s) 240 via an API provided by monitoring system 220.

The equipment data that are collected in subprocess 416 may also comprise physical assessment data acquired by technicians in the field. For example, a technician in the field may physically inspect equipment 222. In addition, the technician may capture one or more images of equipment 222. For example, the technician may utilize a client application 232 on a mobile user system 230 (e.g., smartphone, tablet computer, etc.) to enter inspection information into the graphical user interface via an input device (e.g., touch panel display, keyboard, etc.), and/or capture one or more photographs of equipment 222 via an integrated or connected camera. Client application 232 may upload the inspection information and/or the one or more images of equipment 222 to server application 212 over network(s) 240 (e.g., via wireless communication using antenna 370, such as Wi-Fi® or cellular communications). The inspection information may comprise grades, for equipment 222 and/or individual components of equipment 222 (eg., an enumeration value representing the condition of a component, a numerical value representing the condition of a component, etc.), that are based on one or more predefined grading criteria, or answers to prompts that are used by server application 212 to calculate such grades. Example implementations of graphical user interfaces and functions that may be implemented (e.g., by server application 212, client application 232, and/or a combination of server application 212 and client application 232) to collect equipment data in subprocess 416 are described in U.S. Pat. No. 10,831,185, issued on Nov. 10, 2020, which is hereby incorporated herein by reference as if set forth in full. Notably, the conversion of a physical inspection into grades enables the automation of at least some aspects of the risk assessment, since server application 212 may process the grades in the physical assessment data to automatically determine a current physical condition of equipment 222.

The equipment data that are collected in subprocess 416 may also comprise data that are derived using a physics-based model associated with the equipment 222 that was identified in the request information collected in subprocess 412. For example, the machine data and/or physical assessment data may be input into a physics-based model of equipment 222 and/or compared, verified, or integrated with data from a physics-based model of equipment 222 to calculate the remaining useful life and/or real-time predicted material responses of equipment 222. An example implementation of subprocess 416 that uses a physics-based model to calculate the remaining useful life of a gas turbine engine 100, as one example of equipment 222, is described in U.S. Pat. No. 9,200,984, issued on Dec. 1, 2015, which is hereby incorporated herein by reference as if set forth in full. The physics-based model may be automatically applied to the machine data and/or physical assessment data after this data has been received (e.g., in response to the data being received), or may be applied to the machine data and/or physical assessment data in response to one or more user operations. It should be understood that different equipment or different types of equipment may be associated with different physics-based models. Thus, server application 212 may select a physics-based model that is associated with the equipment 222, identified in the request information, from a plurality of physics-based models (e.g., stored in database 214).

The original useful life of equipment 222, under normal or expected operating conditions, may have been previously predicted using the associated physics-based model to determine the original service interval. As equipment 222 is operated or at the time that a request to extend the service interval is processed, the useful life of equipment 222 may be recalculated, using the actual operating conditions, represented in historical or real-time equipment data (e.g., the machine data derived from the output of sensors 224), as input to the physics-based model. The recalculated useful life will generally be more accurate than the originally calculated useful life. It should be understood that, if equipment 222 is operated under better-than-expected conditions, the recalculated useful life may be significantly longer than the originally calculated useful life, which would generally be indicative of a lower risk in extending the service interval Conversely, if equipment 222 is operated under worse-than-expected conditions, the recalculated useful life may be shorter than the originally calculated useful life, which would generally be indicative of a higher risk in extending the service interval.

It should be understood that, as used herein, the term “remaining useful life of the equipment” may refer to the remaining useful life of the entire equipment 222 as a whole, the remaining useful life of a component of equipment 222, the remaining useful lives of a collection of a plurality of components of equipment 222, and/or a remaining useful life that is determined from the remaining useful lives of a collection of a plurality of components of equipment 222. Thus, the calculated value of the remaining useful life of equipment 222 may be a single value or a set of values that are expressed in any suitable metric for the life of a machine (e.g., operating hours). In the case that the remaining useful life of equipment 222 is calculated as a single value determined from the useful lives of a collection of a plurality of components of equipment 222, the single value may be calculated as the minimum value from among the remaining useful lives of the collection of components.

The collection of the request information in subprocess 412, the documentation in subprocess 414, and/or the equipment data in subprocess 416 may be performed manually by an initial assessor. For example, upon receiving a request to extend a service interval for a particular equipment 222 (e.g., in subprocess 412), the initial assessor may manually collect the data in one or more of subprocesses 412, 414, and 416. In an embodiment, the initial assessor may input data into one or more screens of the graphical user interface. Alternatively or additionally, at least a portion of the collection of the request information in subprocess 412, the documentation in subprocess 414, and/or the equipment data in subprocess 416 may be performed automatically For example, documentation may be retrieved automatically in subprocess 414 based on the identification of equipment 222 in the request information, historical or real-time sensor outputs, or parameter values derived from historical or real-time sensors outputs, may be retrieved automatically in subprocess 416, one or more metrics (e.g., remaining useful life, predicted material responses, etc.) may be automatically calculated using a physics-based model in subprocess 416, and/or the like. Thus, all of the data (i.e., collected by subprocesses 412, 414, and 416) may be collected manually, all of the data may be collected automatically, or a portion of the data may be collected manually and a portion of the data may be collected automatically, depending on the particular implementation.

In subprocess 418, the data collected in subprocesses 412, 414, and 416 are analyzed to form an initial risk assessment. In particular, a risk score may be calculated for each of one or more risk areas based on the collected data that are relevant to the respective risk area. For example, in the context of gas turbine engine 100, the risk areas may include, without limitation, disk life, bearings, vibrations, ancillary risk, internal engine, performance, auxiliary gear box/reduction gear box, lube oil, combustion spread, fuel system, guide vanes, additional risks found in a condition assessment report, and/or the like. The risk score for each risk area may be calculated automatically (e.g., by server application 212) or manually by an initial assessor. Alternatively, the risk scores for some risk areas may be calculated automatically, while the risk scores for other risk area may be calculated manually.

In an embodiment, the risk areas that are included in the risk assessment may depend on the equipment 222 identified in the request information that was collected in subprocess 412. For example, different pluralities of risk areas may be associated with different equipment or types of equipment (e.g., in database 214). Server application 212 may retrieve the plurality of risk areas associated with the equipment 222 or type of equipment 222 that was identified in the request information. In a manual implementation, server application 212 may generate one or more screens of the graphical user interface to solicit a score for each of the retrieved plurality of risk areas from the initial assessor. In an automatic or semi-automatic implementation, server application 212 may automatically generate a score for each of the retrieved plurality of risk areas based on the data collected in subprocesses 412, 414, and/or 416. In an automatic implementation, these automatically generated scores may be incorporated into the initial risk assessment without human intervention. In a semi-automatic implementation, server application 212 may generate one or more screens of the graphical user interface to comprise user-modifiable inputs which are prepopulated with the automatically generated scores or to otherwise recommend or solicit confirmation of the automatically generated scores. In this case, the initial assessor may utilize the graphical user interface to review and potentially modify the scores, and, when satisfied, submit the scores for the plurality of risk areas, which are then incorporated into the initial risk assessment.

The score for each risk area may be represented in any form and according to any scale. As one example, the score for each risk area may be selected from one of a finite enumeration, such as “low” indicating low risk, “medium” indicating medium risk, and “high” indicating high risk. In addition, an overall score for the request may be determined based on the scores for the plurality of risk areas. In this case, a score that indicates a medium or high risk may be weighted higher in computing the overall score than a score that indicates a low risk, to ensure that a medium-risk or high-risk area is not overlooked. Using the example above, if any risk area has a “high” score, the overall score may be set to “high.” If any risk area has a “medium” score and no risk area has a “high” score, the overall score may be set to “medium.” If all risk areas have a “low” score, the overall score may be set to “low.” It should be understood that this is simply one example and that other scoring frameworks (e.g., including different enumerations, numerical scores, including integer or real value scores, etc.) may be used.

The output of subprocess 418 may comprise a recommendation that is determined based on the risk score(s) calculated for the risk area(s) and/or the overall score. The recommendation may be determined automatically (e.g., by server application 212) or manually by the initial assessor. In an embodiment, the recommendation comprises either an approval of the requested amount of service interval extension, an approval of a modified amount of service interval extension (e.g., a number of operating hours that is less than the requested amount of service interval extension), or a denial of the request (e.g., if no amount of service interval extension is advisable). Using the example scoring framework above, an overall score of “low” may be generally indicative of an approval, an overall score of “medium” may be generally indicative of an approval of a modified amount of service interval extension, and an overall score of “high” may be generally indicative of a denial or a significant reduction in the amount of service interval extension. Once the initial risk assessment has been performed in subprocess 418, such that the recommendation has been determined, process 400 may shift from collection stage 410 to evaluation stage 420.

As illustrated, evaluation stage 420 may comprise subprocesses 422, 424, 426, 428, and 429. At a high level, subprocesses 422, 424, 426, and 428 form a loop over one or a plurality of iterations of evaluation of the risk assessment. In instances in which the data collected in collection stage 410 are not sufficient, this loop may comprise a further iteration of collection stage 410.

In subprocess 422, a notification is sent to a subsequent assessor to request an evaluation of the risk assessment performed for equipment 222. The identity of the subsequent assessor may be determined from the request information collected in subprocess 412. For example, server application 212 may extract an identifier of the subsequent assessor from the request information or select a subsequent assessor from a plurality of available assessors having a role indicated in the request information. The notification may automatically be sent to the subsequent assessor upon completion of the risk assessment. For example, in an initial iteration of subprocess 422, as soon as the recommendation has been completed in subprocess 418 (e.g., by the initial assessor manually submitting or confirming the recommendation via the graphical user interface, or by server application 212 automatically generating the recommendation), the notification may be sent to a subsequent assessor (e.g., who is different than the initial assessor) to evaluate the recommendation. The notification may comprise an internal message (e.g., using a messaging service implemented by server application 212) to a user account associated with the subsequent assessor, an email message to an email address associated with the subsequent assessor, a text message (e.g., using Short Message Service (SMS) or Multimedia Messaging Service (MMS)) to a mobile number associated with the subsequent assessor, and/or the like.

Similarly, one or more other users may also be notified, in subprocess 422, each time an assessment is completed. The identity of these user(s) may be determined from the request information collected in subprocess 412. For example, server application 212 may extract an identifier of each of these user(s) from the request information. The notification may automatically be sent to the user(s) upon completion of the risk assessment using internal messaging, an email message, a text message, and/or the like. In addition, a notification may be automatically sent whenever the risk assessment is modified, an evaluation of the risk assessment is completed, and/or upon the occurrence of any other notable event during the review process for the request for service interval extension that was received in subprocess 405. Thus, the user(s) may be kept informed of the current progress of the review process and/or any notable events in the review process. It should be understood that these user(s) may include the customer that requests the service interval extension, an administrator, and operations manager or other supervisory authority, and/or any other stakeholders in equipment 222.

The subsequent assessor may log in to an associated account with server application 212 to review and evaluate the risk assessment performed by the prior assessor. The risk assessment may be available for review from a dashboard or other screen of the graphical user interface generated for the subsequent assessor’s account. The risk assessment may comprise the data on which the risk assessment is based (e.g., all data collected in subprocesses 412, 414, and 416), all risk score(s) for the risk area(s), the overall score, and/or the determined recommendation.

As part of the evaluation, the subsequent assessor may determine whether or not the data collected in collection stage 410 are satisfactory. For example, the collected data may be determined to be unsatisfactory if there are missing or insufficient data, out-of-date data (e.g., newer data is available), erroneous data, unreliable data, irrelevant data, and/or the like. The subsequent assessor may indicate whether or not the collected data are satisfactory via one or more inputs in a screen of the graphical user interface, and server application 212 may determine whether or not the collected data are satisfactory in subprocess 424 based on the indication input by the subsequent assessor. Alternatively or additionally, server application 212 may automatically determine whether or not the collected data are unsatisfactory, for example, based on metadata or other attributes of the collected data. For example, data with timestamps that indicate the data are older than a predefined threshold may be determined to be unsatisfactory.

If the collected data are determined to be satisfactory (i.e., “Yes” in subprocess 426), process 400 proceeds to subprocess 426. Otherwise, if the collected data are determined to be unsatisfactory (i.e., “No” in subprocess 426), process 400 returns to collection stage 410. In this case, the data may be recollected or supplemented in one or more, including potentially all, of subprocesses 412, 414, and 416. Then, a new or updated risk assessment may be performed in subprocess 418 (e.g., by the same initial assessor or automatically). Once the risk assessment has been completed in subprocess 418, the same or different subsequent assessor may once again be notified of the completed risk assessment in subprocess 422.

In subprocess 426, the subsequent assessor may review the risk assessment and provide an evaluation that either confirms or modifies the risk assessment, including confirming or modifying the recommendation. The subsequent assessor may indicate confirmation of the recommendation (e.g., confirm the amount of service interval extension recommended by the prior assessor) via one or more inputs in a screen of the graphical user interface. Otherwise, the subsequent assessor may modify the recommendation via one or more inputs in a screen of the graphical user interface. The subsequent assessor may modify the recommendation by, for example, decreasing the amount of service interval extension recommended by the prior assessor (e.g., decreasing the number of operating hours to be granted in the service interval extension), increasing the amount of service interval extension recommended by the prior assessor (e.g, increasing the number of operating hours to be granted in the service interval extension closer to or up to the requested amount), or denying the service interval extension altogether.

In an embodiment, process 400 comprises subprocess 428. In an alternative embodiment, subprocess 428 may be omitted, such that process 400 proceeds from subprocess 426 to subprocess 429 without passing through subprocess 428. In an embodiment that includes subprocess 428, server application 212 may determine, in subprocess 428, whether or not a further evaluation of the risk assessment is warranted, based on one or more criteria. These one or more criteria may include the recommendation of the subsequent assessor. For example, if the recommendation of the subsequent assessor differs from the recommendation of the initial assessor, server application 212 may determine that a further evaluation is warranted. As another example, a modification (or alternatively, a significant modification, e.g., a change in the absolute amount of the service interval extension that exceeds a threshold) by the subsequent assessor of the recommendation of the prior assessor may be a criterion that favors a further evaluation, whereas a confirmation (or alternatively, a confirmation or insignificant modification) by the subsequent assessor of the recommendation of the prior assessor may be a criterion that favors no further evaluation. Additionally or alternatively, the one or more criteria may include features of the collected data from collection stage 410 and/or equipment-specific conditions. For example, specific types of equipment 222 (e.g., a specific engine) may always warrant further evaluation (e.g., a predetermined number of iterations of evaluation stage 420). As another example, a significant deviation (e.g., exceeding a threshold) between the remaining useful life of equipment 222, calculated by the physics-based model in subprocess 416, and the operating hours of equipment 222 with the service interval extension may be a criterion that favors a further evaluation, whereas no deviation or an insignificant deviation (e.g., below a threshold) between the remaining useful life of equipment 222, calculated by the physics-based model in subprocess 416, and the operating hours of equipment 222 with the service interval extension may be a criterion that favors no further evaluation. Additionally or alternatively, the one or more criteria may comprise the presence of another tier of evaluation in a hierarchy of evaluations. For example, if another tier of evaluation remains to be completed in the hierarchy of evaluations, in subprocess 428, server application 212 will determine that further evaluation is required, select an assessor with a role representing the next tier in the hierarchy of evaluations, and notify the selected assessor in subprocess 422 In this tiered approach, server application 212 may determine the hierarchy of evaluations and/or the assessors or roles to be used in each tier of the hierarchy of evaluations from the request information that was collected in subprocess 412. It should be understood that, in this tiered approach, each iteration of evaluation stage 420 represents a completed tier in the hierarchy of evaluations, and that the iterations of evaluation stage 420 may be performed in sequence from the lowest tier to the highest tier in the hierarchy until all tiers in the hierarchy have been completed.

If a further evaluation is determined to be warranted (i.e., “Yes” in subprocess 428), process 400 returns to subprocess 422 to send a new notification to another subsequent assessor to request another evaluation of the risk assessment performed for equipment 222. This notification may be automatically sent upon the determination that the further evaluation is warranted. It is generally contemplated that the subsequent assessor, to which the new notification is sent, should be different than the assessor to which the prior notification was sent in the prior iteration of subprocess 422 and who reviewed the risk assessment and either confirmed or modified the recommendation in subprocess 426. In other words, each iteration of the loop formed by subprocesses 422, 424, 426, and 428 may be performed with a different assessor. However, it should be understood that this does not have to be the case, and that two or more iterations of this loop may be performed by the same assessor. In addition, it should be understood that an initial assessor, who performed the risk assessment in subprocess 418, could also be a subsequent assessor that performs an evaluation in at least one iteration of the loop formed by subprocesses 422, 424, 426, and 428. In a tiered approach, each iteration of the loop, formed by subprocesses 422, 424, 426, and 428, may be performed by an assessor that is at a higher level (e.g., in terms of seniority, expertise, an organizational chart, etc.) than each prior assessor.

Each assessor that participates in an iteration of the loop, formed by subprocesses 422, 424, 426, and 428, may be required to perform specific tasks based on the iteration. For example, a second iteration may require different tasks to be performed than the first iteration. These tasks may include performing a risk assessment, reviewing a previously performed risk assessment, and/or the like. Thus, some assessors may be required to perform a risk assessment or more thorough review of the risk assessment, whereas other assessors may only be required to cursorily review a previously performed risk assessment. In an ideal scenario, only the initial assessor would need to perform a risk assessment, whereas all subsequent assessor(s) would merely review the initial assessor’s risk assessment to either confirm the initial assessor’s recommendation (e.g., in subprocess 426) or return the risk assessment to the initial assessor to reconsider the risk assessment (e.g., via a determination of “No” in subprocess 424) and/or modify the initial assessor’s recommendation (e.g., in subprocess 426). However, in an embodiment, subsequent assessors retain the ability to modify one or more, including potentially all, portions of the risk assessment (e.g., via one or more inputs of the graphical user interface). In an embodiment, each assessor in each iteration of the loop formed by subprocesses 422, 424, 426, and 428 submits a recommendation (e.g., by confirming or modifying the recommendation of a prior assessor, or generating a new recommendation).

If no further evaluation is determined to be warranted (i.e, “No” in subprocess 428), a notification is sent to a final assessor (e.g., an operations manager) to request a final evaluation of the risk assessment performed for equipment 222. This notification may be automatically sent by server application 212 upon completion of the most recent evaluation and the determination that no further evaluation is warranted. Preferably, the final assessor is different than any of the prior assessors. The notification may comprise an internal message (e.g., using a messaging service implemented by server application 112) to a user account associated with the final assessor, an email message to an email address associated with the final assessor, a text message (e.g., using SMS or MMS) to a mobile number associated with the final assessor, and/or the like.

In subprocess 432, the final assessor may review the most recent recommendation by the last assessor or all recommendations from all assessors. The final assessor may also review the rest of the risk assessment forming the basis of the reviewed recommendation(s). In an embodiment, the final assessor may have the ability to request further evaluation (e.g., via one or more inputs in a screen of the graphical user interface), including sending the request for the service interval extension back to the initial assessor (e.g., if the collected data is unsatisfactory). Based on the review and/or other considerations (e.g., business considerations), the final assessor may make a final determination as to whether the service interval extension will be approved or denied, and, if the service interval extension will be approved, the amount of the service interval extension that will be approved. This final determination may be submitted via one or more inputs of a screen of the graphical user interface, and server application 212 may store and/or communicate a final decision on the request for a service interval extension based on the submitted determination. If the final determination is that the service interval extension will be denied (i.e., “No” in subprocess 432), the request is denied in subprocess 434. Otherwise, if final determination is that the service interval extension will be approved (i.e., “Yes” in subprocess 432), the request is approved in subprocess 436. This final determination may be provided to the customer who submitted the request in subprocess 405. For example, the final determination may be communicated to the customer via an internal message to a user account associated with the customer, an email message to an email address associated with the customer, a text message to a mobile number associated with the customer, a telephone call to a telephone number associated with the customer, and/or the like.

### Industrial Applicability

Frequently, owners or operators of turbomachinery, such as gas turbine engine 100, or other equipment 222 will request the original equipment manufacturer or other party to extend the service interval or time before overhaul for the equipment 222. Prior to extending the service interval, it is prudent to perform a risk assessment. Conventionally, such risk assessments have had to be performed entirely manually due to obstacles to automating various required tasks.

Disclosed embodiments overcome one or more of these obstacles to facilitate and automate many aspects, and potentially all aspects, of the risk assessment. For example, collection stage 410 aggregates data from a plurality of different, disparate data silos, such that the data can be analyzed in a single, convenient format (e.g, manually or semi-automatically via a graphical user interface, or fully automatically). Collection stage 410 may also utilize a physics-based model to automate the calculation of a remaining useful life of equipment 222, which can then be used to automate or otherwise facilitate further aspects of the risk assessment and improve confidence in the risk assessment. In addition, evaluation stage 420 enables iterative evaluation, while automatically keeping all stakeholders informed of the current progress in the review process, until a final decision is made to either approve or deny the request for a service interval extension.

Notably, the disclosed embodiments are capable of being implemented in a fully automatic mode to approve or deny requests for service interval extensions without human intervention. However, in the context of turbomachinery, in which a failure may be dangerous, as well as costly, it is generally best to maintain at least some human oversight. Thus, in an embodiment, human assessors are used to perform the risk assessments, or at least review automatically performed risk assessments prior to submission of a recommendation. In any case, the disclosed embodiments increase automation within the review process, and, more generally, provide the technological framework for semi-automation or full automation of the review process.

It will be understood that the benefits and advantages described above may relate to one embodiment or may relate to several embodiments. Aspects described in connection with one embodiment are intended to be able to be used with the other embodiments. Any explanation in connection with one embodiment applies to similar features of the other embodiments, and elements of multiple embodiments can be combined to form other embodiments. The embodiments are not limited to those that solve any or all of the stated problems or those that have any or all of the stated benefits and advantages.

The preceding detailed description is merely exemplary in nature and is not intended to limit the invention or the application and uses of the invention. The described embodiments are not limited to usage in conjunction with a particular type of machine. Hence, although the present embodiments are, for convenience of explanation, depicted and described as being implemented for turbomachinery, such as a gas turbine engine, it will be appreciated that they can be implemented for various other types of machines, and in various other systems and environments. Furthermore, there is no intention to be bound by any theory presented in any preceding section. It is also understood that the illustrations may include exaggerated dimensions and graphical representation to better illustrate the referenced items shown, and are not considered limiting unless expressly stated as such.

What is claimed is:

1. A method comprising using at least one hardware processor to:
receive request information, representing a request for a service interval extension for an equipment, the request information including a requested amount of the service interval extension;
collect equipment data, including actual operating parameters of the equipment;
apply a physics-based model, associated with the equipment, to the equipment data to calculate a remaining useful life of the equipment;
generate a risk assessment based on the equipment data and the remaining useful life of the equipment, the risk assessment including a recommended amount of the service interval extension; and
either approve or deny the service interval extension for the recommended amount based on the risk assessment.

2. The method of claim 1, wherein collecting equipment data comprises receiving machine data, derived from an output of one or more sensors that each measure an operating parameter of the equipment, from a monitoring system over at least one network.

3. The method of claim 1, wherein each of the requested and recommended amount of service interval extension and the remaining useful life of the equipment comprises an amount of operating hours.

4. The method of claim 1, further comprising using the at least one hardware processor to, before either approving or denying the service interval extension, in each of one or more iterations:
identify an assessor;
provide the risk assessment to the identified assessor;
receive an evaluation of the risk assessment from the identified assessor;
determine whether or not further evaluation is warranted;
when determining that further evaluation is warranted, add an iteration to the one or more iterations; and,
when determining that no further evaluation is warranted, provide the risk assessment to a final assessor for approval or denial of the service interval extension.

5. The method of claim 4, wherein, in each of the one or more iterations, the assessor is identified based on the request information.

6. The method of claim 4, wherein the evaluation comprises a confirmation of the risk assessment.

7. The method of claim 4, wherein the evaluation comprises a modification of the recommended amount of the service interval extension.

8. The method of claim 4, wherein the one or more iterations are a plurality of iterations, and a different assessor is identified in each of the plurality of iterations.

9. The method of claim 4, wherein determining whether or not further evaluation is warranted comprises determining that a further evaluation is warranted when the evaluation does not confirm the risk assessment.

10. The method of claim 4, wherein the one or more iterations are a plurality of iterations representing completions of tiers in a hierarchy of evaluations, and determining whether or not further evaluation is warranted comprises determining that a further evaluation is warranted when an uncompleted tier remains in the hierarchy of evaluations.

11. The method of claim 1, wherein generating a risk assessment comprises:
receiving one or more inputs from an initial assessor; and
creating the risk assessment based on the one or more inputs.

12. The method of claim 11, further comprising using the at least one hardware processor to, before either approving or denying the service interval extension, in each of one or more iterations:
identify a subsequent assessor that is different than the initial assessor;
provide the risk assessment to the subsequent assessor;
receive a user operation from the subsequent assessor that indicates whether or not the risk assessment is based on satisfactory data; and,
when the user operation indicates that the risk assessment is not based on satisfactory data, request the initial assessor to generate a new risk assessment.

13. The method of claim 1, wherein the risk assessment comprises a score for each of a plurality of risk areas.

14. The method of claim 13, further comprising using the at least one hardware processor to select the plurality of risk areas based on the equipment.

15. The method of claim 1, wherein the equipment data further includes inspection grades for one or more components of the equipment.

16. The method of claim 1, further comprising using the at least one hardware processor to collect documentation associated with the equipment.

17. The method of claim 1, wherein the equipment comprises a turbomachine.

18. The method of claim 17, wherein the turbomachine is a gas turbine engine.

19. A system comprising:
at least one hardware processor; and
one or more software modules that are configured to, when executed by the at least one hardware processor,
receive request information, representing a request for a service interval extension for an equipment, the request information including a requested amount of the service interval extension,
collect equipment data, including actual operating parameters of the equipment,
apply a physics-based model, associated with the equipment, to the equipment data to calculate a remaining useful life of the equipment,
generate a risk assessment based on the equipment data and the remaining useful life of the equipment, the risk assessment including a recommended amount of the service interval extension, and
either approve or deny the service interval extension for the recommended amount based on the risk assessment.

20. A non-transitory computer-readable medium having instructions stored therein, wherein the instructions, when executed by a processor, cause the processor to:
receive request information, representing a request for a service interval extension for an equipment, the request information including a requested amount of the service interval extension;
collect equipment data, including actual operating parameters of the equipment;
apply a physics-based model, associated with the equipment, to the equipment data to calculate a remaining useful life of the equipment;
generate a risk assessment based on the equipment data and the remaining useful life of the equipment, the risk assessment including a recommended amount of the service interval extension; and
either approve or deny the service interval extension for the recommended amount based on the risk assessment.
